(19) United States
(12) Patent Application Publication
(10) Pub. No.: US 2009/0252129 A1
(43) Pub. Date: Oct. 8, 2009

(54) Known station hidden network discovery

(75) Inventor: Mikko Jaakkola, Lempaala (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/080,992

(22) Filed: Apr. 8, 2008

(51) Int. Cl. H04Q 7/24

(52) U.S. Cl. 370/338

(57) ABSTRACT

A method includes storing a table that contains identifications of certain ones of network devices and, when operating a wireless network access node in a hidden mode of operation, transmitting a probe response only to a probe request that is received from a network device having an identification stored in the table.

### TECHNICAL FIELD

The exemplary and non-limiting embodiments of this invention relate generally to wireless communication systems, methods, devices, apparatus and computer programs and, more specifically, relate to techniques to facilitate the wireless connection of a device or station with an access point when the access point does not make its identification known.

### BACKGROUND

There presently are several wireless local area networks that use a hidden mode technique as a security method. In this hidden mode the network name, such as a service set identifier (SSID), is not transmitted. In general, the only viable technique for a device to discover such a network is to send a directed probe request frame with a matching network name identified by the SSID. Normally, such hidden networks do not send a response to a broadcast probe request (i.e., to a received frame that requests all networks to identify themselves). For a device that is not aware of its current location the hidden network discovery process can be a very slow process, as it must cycle though all of the profiles in the wireless local area system to locate the correct network, or use passive scanning.

For a non-power-constrained device, such as a personal computer, this approach is viable. However, for mobile devices with limited power availability this type of polling process can be very slow and, furthermore, can consume a significant amount of operating power.

At present, the sending of a directed probe request is the only known viable technique to discover a hidden wireless local area network.

### SUMMARY

The foregoing and other problems are overcome, and other advantages are realized, in accordance with the non-limiting and exemplary embodiments of this invention.

In accordance with a first aspect of the exemplary embodiments of this invention a method includes storing a table that contains identifications of certain ones of network devices and, when operating a wireless network access node in a hidden mode of operation, transmitting a probe response only to a probe request that is received from a network device having an identification stored in the table.

In accordance with another aspect of the exemplary embodiments of this invention there is provided a computer readable memory medium that stores program instructions, the execution of the program instructions resulting in operations that comprise storing a table that contains identifications of certain ones of network devices; and when operating a wireless network access node in a hidden mode of operation, only transmitting a probe response to a probe request that is received from a network device having an identification stored in the table.

In accordance with another aspect of the exemplary embodiments of this invention there is provided an apparatus that includes a wireless transceiver and a controller configurable to operate the apparatus as a wireless network access node. The controller is configurable to respond to operating in a hidden mode of operation, where the apparatus does not transmit an identifier, to transmit a probe response after receiving a probe request from a network device having an identification stored in a table that contains identifications of certain network devices.

In accordance with another aspect of the exemplary embodiments of this invention a method includes storing a table that contains identifications of certain ones of network devices and communicating at least part of a content of the table to at least one wireless network access node for use when operating the wireless network access node in a hidden mode of operation, whereby the wireless network access node transmits a probe response to a probe request that is received from a network device having an identification stored in the table.

In accordance with yet another aspect of the exemplary embodiments of this invention an apparatus includes means for storing a plurality of medium access control addresses individual ones of which are associated with an individual one of an authorized network device; and means, responsive to operation of a wireless network access node in a hidden mode of operation, for transmitting a probe response only to a probe request that is received from a network device having a medium access control address in said storing means.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1 is a block diagram of a wireless communication system that is constructed and operated in accordance with the exemplary and non-limiting embodiments of this invention.

FIG. 2 is a logic flow diagram that illustrates a method performed by, and the result of execution of computer program instructions by the wireless network access node(s) or point(s) shown in FIG. 1.

FIG. 3 is a logic flow diagram that illustrates a method performed by, and the result of execution of computer program instructions by a network node external to the wireless network access node(s) or point(s) shown in FIG. 1, such as by the server shown in FIG. 1.

### DETAILED DESCRIPTION

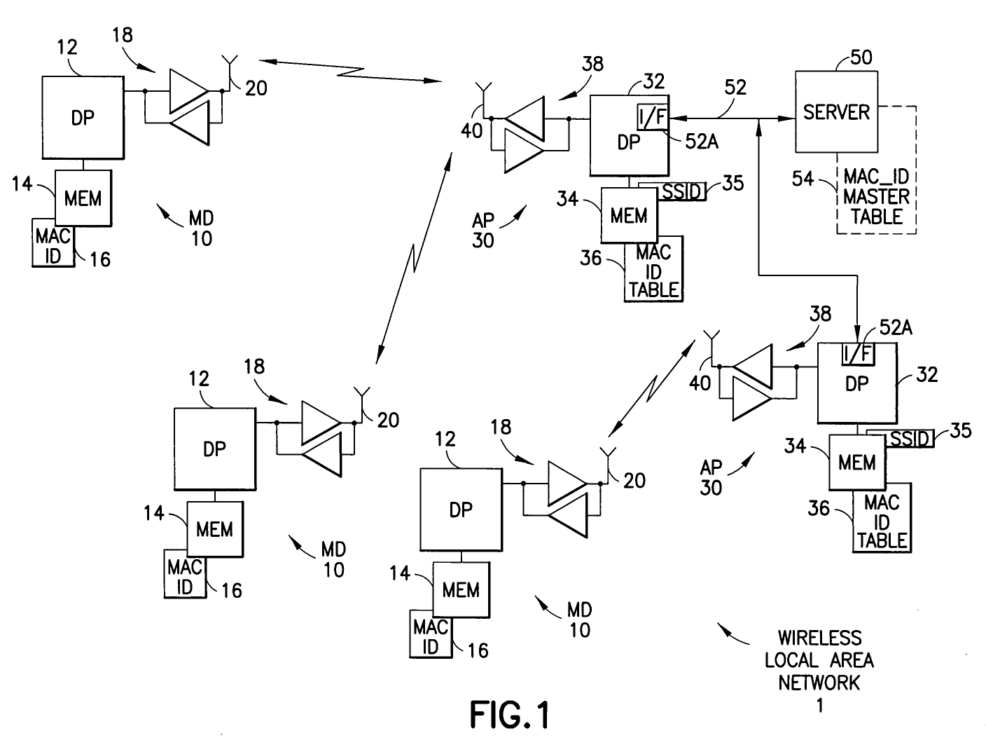

Reference is made first to FIG. 1 for illustrating a simplified block diagram of various electronic devices that are suitable for use in practicing the exemplary embodiments of this invention. In FIG. 1 a wireless network, such as a wireless local area network (WLAN) 1 is adapted for communication with devices, such as mobile devices (MDs) 10, via at least one access point (AP) 30. Although three MDs 10 and two APs 30 are shown, there may be more or less than this number present at any particular time. In some embodiments a network node, such as a server 50, is connected with the APs 30 via a link 52 and a suitable interface (I/F) 52A. The server 50 may provide localized control over the APs 30, and in some embodiments may be considered to function as a WLAN controller.

It should be noted that while FIG. 1 depicts various mobile devices 10, the exemplary embodiments may be used as well with non-mobile network connectable devices including, but not limited to, desk-top and other types of PCs and workstations, including media-center PCs, having a WLAN interface, as well as with certain types of set-top boxes having a WLAN interface for use with internet protocol (IP) based television, as well as with equipment having a WLAN interface for use with voice over IP (VoIP) telephone systems. As such, it should be appreciated that the use of the exemplary embodiments of this invention does not require that the user devices, which may also be referred to generally as network devices or network apparatus, be mobile devices, or that the user devices even be capable of portability or mobility. Further still, the wireless network may be based on radio frequency transmission and reception and/or it can be based on optical (e.g., infrared) transmission and reception.

In general, the various embodiments of the MDs 10 can include, but are not limited to, cellular phones, personal digital assistants (PDAs) having wireless communication capabilities, computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as units or terminals that incorporate combinations of such functions.

Each MD 10 includes a data processor (DP) 12, a memory (MEM) 14 that stores a program suitable to operate the MD 10, and a suitable radio frequency (RF) transceiver 18 that is appropriate for conducting bidirectional wireless communications with the AP 30 via at least one antenna 20. The AP 30 may also include at least one DP 32, a MEM 34 that stores a PROG, and a suitable RF transceiver 38 connected with at least one antenna 40. The APs 30 are shown coupled via the data path (link) 52 to the server 50 that also includes suitable data processing and program storing memory apparatus (not shown). At least one of the programs of the AP 30 and/or server 50 is assumed to include program instructions that, when executed by the associated DP, enable the electronic device to operate in accordance with the exemplary embodiments of this invention, as will be discussed below in greater detail.

The exemplary embodiments of this invention may be implemented by computer software executable by at least the DP 32 of the APs 30, or by hardware, or by a combination of software and hardware (and firmware).

The MEMs 14, 34 may be of any type suitable to the local technical environment and may be implemented using any suitable data storage technology, such as semiconductor-based memory devices, flash memory, magnetic memory devices and systems, optical memory devices and systems, fixed memory and removable memory. The DPs 12, 32 may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments relate to WLAN (e.g., IEEE 802.11) technology and network discovery schemes. As such, the MDs 10 and the APs 30 may be assumed to be compatible with one or more WLAN standards and protocols, such as one known as, or based on, or that is similar to IEEE Std 802.11-1999, and possibly also the supplement thereto known as IEEE 802.11b-1999 (see, for example, IEEE Std 802.11b-1999 (Supplement to ANSI/IEEE Std 802.11, 1999 Edition), Supplement to IEEE Standard for Information technology Telecommunications and information exchange between systems-Local and metropolitan area networks-Specific requirements-Part 11: Wireless LAN Medium Access Control (MAC) and Physical Layer (PHY) specifications: Higher-Speed Physical Layer Extension in the 2.4 GHz Band, which is incorporated by reference herein).

In accordance with the exemplary embodiments of this invention, the WLAN AP 30 has knowledge of at least some MD Medium Access Control (MAC) addresses (referenced in FIG. 1 as a unique or semi-unique MAC_ID 16 that is stored in each MD 10). The MAC_ID is included with a broadcast probe request transmitted by a MD 10. Each AP 30 may thus store a MAC_ID table 36 where at least some of these MD 10 MAC_IDs are recorded (those associated with authorized or pre-approved users). Each AP 30 may also be assumed to store an associated and unique service set identifier (SSID) 35. When operating as a hidden SSID network the SSID 35 is not transmitted by the AP 30 in a beacon message. In accordance with exemplary embodiments of this invention, when operating in the hidden mode the AP 30 responds to the receipt of a particular broadcast probe request that is sent by a MD 10 whose MAC_ID is stored in the MAC_ID table 36. If a received broadcast probe request contains a MAC_ID that does not correspond to one stored in the MAC_ID table 36, then the AP 30 follows conventional operational practice and does not respond to the (unknown or unauthorized) MD 10.

Note that these exemplary embodiments, while discussed in the context of a WLAN system, are not limited thereto, and may be employed to advantage in other wireless or even fixed wire technologies that employ some type of hidden network scheme.

In operation, the MD 10 probes the WLAN 1 in a conventional fashion and performs authentication and association. After a 4-way handshake (if Wi-Fi protected access (WPA) or Wi-Fi protected access 2 (WPA2) is being used, otherwise immediately after the association), the WLAN AP 30 may store the address (the MAC_ID) of the MD 10 into the memory 34, more specifically into a data structure referred to herein for convenience, and not as a limitation, as the MAC_ID table 36. Alternatively, or in conjunction with this MD discovery approach, the MAC_IDs of certain predetermined MDs 10 (e.g., well-known MDs, such as those known to be associated with a certain enterprise that is associated with the WLAN 1) may be installed beforehand into the MAC_ID table 36 of the AP 30. A portion of the memory 34 (such as cache memory) that stores the MAC_ID table 36 may be located in RAM of the WLAN AP 30, or in some non-volatile memory storage device such as flash memory (as a non-limiting example). For example, a 10 kB cache memory may hold approximately 1700 MAC addresses (MAC_IDs) associated with a population of MDs 10.

After the WLAN AP 30 considers a certain MD 10 to be a known MD (evidenced at least by storage of the MAC_ID of the MD 10 in the MAC_ID table 36) it may then immediately respond to a broadcast probe request received from the known MD 10, as if it were operating as a visible and not as a hidden WLAN AP. In this manner the WLAN network 1 can remain hidden from (inaccessible to) those MDs considered to be foreign and/or not approved or authorized to access the WLAN network 1, while remaining visible and accessible to certain (known or friendly) MDs 10.

At present, there is a stringent timing requirement of 5 milliseconds for the AP 30 to respond to a probe request with a probe response. However, this requirement is not seen to represent an impediment to the use of the exemplary embodiments, as the DP 32 of the WLAN AP 30 may typically perform a look-up operation in the MAC_ID table 36 for thousands of MDs within a 5 millisecond period.

It should be noted that the WLAN AP 30 may manage and revise the content of the MAC_ID table 36 in one or more suitable ways. For example, the least recently used or seen MAC_IDs can be automatically removed on some periodic basis, and/or all MAC_ID table 36 entries may be periodically removed.

The WLAN AP 3.0 may also indicate by signaling or by other means that it supports the recording of known MDs as described above. In this case, a particular MD 10 is informed that it need not poll the associated SSID. This can significantly optimize the power-consumption of the MDs 10.

The use of these exemplary embodiments provides a technique to make the AP 30 operating with the hidden SSID user friendly to the population of MDs 30, as it can appear as a normal (non-hidden) WLAN AP for certain well-known or authorized MDs 10. In practice, network discovery is made faster and thus less power consuming from the point of view of the MDs 10.

It should be noted that each AP 30 may separately and independently establish, maintain and manage the associated MAC_ID table 36A. However, in a further exemplary embodiment there may be a MAC_ID master table 54 stored at a central location, such as at the server 50 (or in any network infrastructure node, such as in a backend server or WLAN controller, that is external to the APs 30). In this case, the global MAC_ID master table is maintained at the server 50 and distributed to each connected AP 30 via the interface 52A. For example, in an enterprise environment the server 50 maintains, possibly with the assistance of an administrator, the enterprise-wide MAC_ID master table 5. If a change is made to the table then the updated MAC_ID tables can be distributed via the link 52 to all connected APs 30. Alternatively, or in combination with the distributed updates, an individual one of the APs 30 can request a most-recent copy of the MAC_ID master table 54, and then store it locally as the MAC_ID table 56.

Note further that in some exemplary embodiments of this invention the overall MAC-related protocol (and also higher) layer functionality may be implemented in a network node other than the APs 30 (such the server 50), and only the lower layer (e.g., physical) functions are performed and managed by the AP 30. In such an exemplary case it is clearly appropriate that the MAC_ID table 36A be stored, maintained and managed (and possibly also revised as discussed above) at a location other than the AP 30.

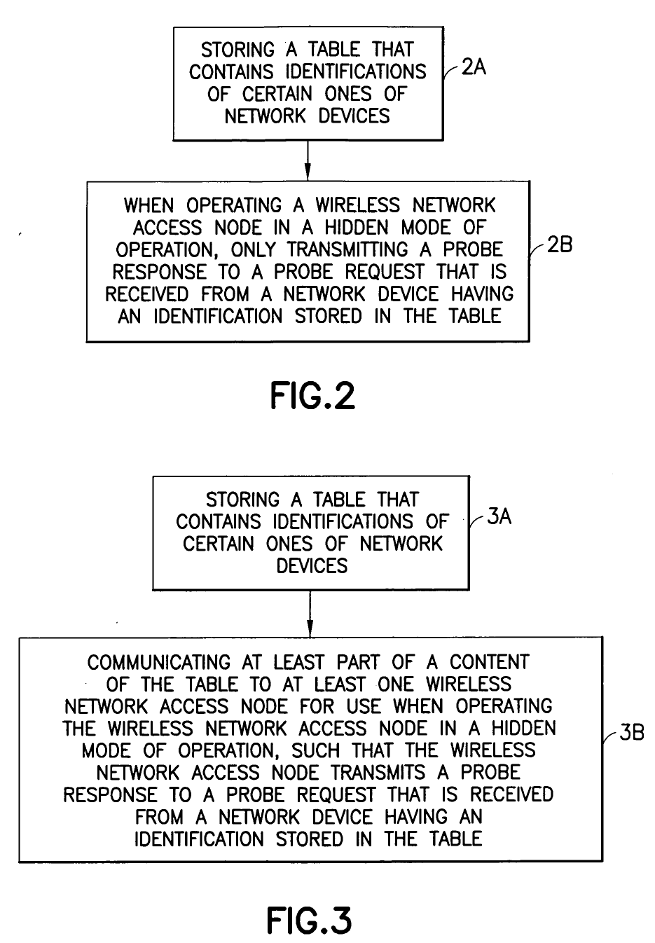

Based on the foregoing it should be apparent that the exemplary embodiments of this invention provide a method, apparatus and computer program(s) to facilitate operation of the MDs 10 in the WLAN 1. In accordance with an exemplary method, and referring to FIG. 2, at Block 2A there is a step of storing a table that contains identifications of certain ones of network devices and, at Block 2B, when operating a wireless network access node in a hidden mode of operation, only transmitting a probe response to a probe request that is received from a network device having an identification stored in the table.

In the method (and computer program) of the preceding paragraph, where the probe request is a broadcast probe request.

In the method (and computer program) of the preceding paragraphs where the table is maintained by the network access node, or is maintained by a network node other than the wireless network access node.

In the method (and computer program) of the preceding paragraph where when the table is maintained by the network node other than the wireless network access node, the table is at least one of communicated to the wireless network access node and interrogated by the wireless network access node.

In the method (and computer program) of the preceding paragraphs, where the identification is comprised of a medium access control address of the network device.

In the method (and computer program) of the preceding paragraphs, where when operating in the hidden mode the wireless network access node does not transmit an associated service set identifier.

In the method (and computer program) of the preceding paragraphs, further including an initial step of storing the identification of a particular network device in the table only after an initial step of authenticating and associating the network device.

In the method (and computer program) of the preceding paragraphs, where the wireless network access node and the network device operate in accordance with a wireless local area network protocol.

In the method (and computer program) of the preceding paragraphs, where the network device is a mobile device.

In the method (and computer program) of the preceding paragraphs, further comprising periodically revising the content of the table to at least one of store a new medium access control address and remove a previously stored medium access control address.

In accordance with another exemplary method, and referring to FIG. 3, at Block 3A there is a step of storing a table that contains identifications of certain ones of network devices; and at Block 3B there is a step of communicating at least part of a content of the table to at least one wireless network access node for use when operating the wireless network access node in a hidden mode of operation, such that the wireless network access node transmits a probe response to a probe request that is received from a network device having an identification stored in the table.

The method (and computer program) of the previous paragraph, where an identification is comprised of a medium access control address of a network device.

It should thus be noted that the various blocks shown in FIGS. 2 and 3 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is largely a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations may become apparent to those skilled in the relevant arts in view of the foregoing description, when read in conjunction with the accompanying drawings and the appended claims. As but some examples, the use of different, similar or equivalent types of MDs 10 may be attempted by those skilled in the art. Furthermore, in some network embodiments the server 50 may store the individual MAC_ID tables 36 for the APs 30, which are then interrogated and possibly also updated by the APs 30 as needed (or the MAC_ID master table 54 may be interrogated by the APs 30). In this case the server 50 need not provide the entire MAC_ID master table 54 to a particular AP 30, but may instead provide just a part of it (or may simply provide a reply to an interrogation by an AP 30 as to whether a particular MAC_ID is or is not found in the MAC_ID master table 54. However, all such and similar modifications of the teachings of this invention will still fall within the scope of this invention.

Further, while the exemplary embodiments have been described above generally in the context of an IEEE 802.11-type of system, it should be appreciated that the exemplary embodiments of this invention are not limited for use with only this one particular type of wireless communication system, and that they may be used to advantage in other types of wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
storing a table that contains identifications of certain ones of network devices; and
when operating a wireless network access node in a hidden mode of operation, transmitting a probe response only to a probe request that is received from a network device having an identification stored in the table.

2. The method of claim 1, where the probe request is a broadcast probe request.

3. The method of claim 1 where the table is maintained by the network access node.

4. The method of claim 1 where the table is maintained by a network node other than the wireless network access node.

5. The method of claim 1 where the table is maintained by a network node and is at least one of communicated to the wireless network access node and interrogated by the wireless network access node.

6. The method of claim 1, where the identification is comprised of a medium access control address of the network device.

7. The method of claim 1, where when operating in the hidden mode the wireless network access node does not transmit an associated service set identifier.

8. The method of claim 1, comprising an initial step of storing the identification of a particular network device in the table only after an initial step of authenticating and associating the network device.

9. The method of claim 1, where the wireless network access node and the network device operate in accordance with a wireless local area network protocol.

10. The method of claim 1, where the network device is a mobile device.

11. The method of claim 1, further comprising periodically revising the content of the table to at least one of store a new medium access control address of a network device and remove a previously stored medium access control address of a network device.

12. A computer readable memory medium that stores program instructions the execution of which results in operations that comprise:
storing a table that contains identifications of certain ones of network devices; and
when operating a wireless network access node in a hidden mode of operation, only transmitting a probe response to a probe request that is received from a network device having an identification stored in the table.

13. The computer readable memory medium of claim 12, where the probe request is a broadcast probe request.

14. The computer readable memory medium of claim 12, where the table is maintained by the network access node.

15. The computer readable memory medium of claim 12, where the table is maintained by a network node other than the wireless network access node.

16. The computer readable memory medium of claim 12, where the table is maintained by a network node and is at least one of communicated to the wireless network access node and interrogated by the wireless network access node.

17. The computer readable memory medium of claim 12, where the identification is comprised of a medium access control address of the network device.

18. The computer readable memory medium of claim 12, where when operating in the hidden mode the wireless network access node does not transmit an associated service set identifier.

19. The computer readable memory medium of claim 12, comprising an initial operation of storing the identification of a particular network device in the table only after authenticating and associating the network device.

20. The computer readable memory medium of claim 12, where the wireless network access node and the network device operate in accordance with a wireless local area network protocol.

21. The computer readable memory medium of claim 12, where the network device is a mobile device.

22. The computer readable memory medium of claim 12, further comprising an operation of periodically revising the content of the table to at least one of store a new medium access control address of a network device and remove a previously stored medium access control address of a network device.

23. An apparatus, comprising:
a wireless transceiver; and
a controller configurable to operate the apparatus as a wireless network access node, said controller configurable, in response to operating in a hidden mode of operation where the apparatus does not transmit an identifier, to transmit a probe response after receiving a probe request from a network device having an identification stored in a table containing identifications of certain network devices.

24. The apparatus of claim 23, where the probe request is a broadcast probe request.

25. The apparatus of claim 23, where the table is maintained by the wireless network access node, or is maintained by a network node other than the wireless network access node.

26. The apparatus of claim 23, where the table is maintained by a network node and further comprising an interface configurable to at least one of receive the table from the network node and interrogate the table at the network node.

27. The apparatus of claim 23, where the identification is comprised of a medium access control address of the network device.

28. The apparatus of claim 23, where the identification of a particular network device is stored in the table only after operations are performed to authenticate and associate the network device.

29. The apparatus of claim 23 where the wireless network access node and the network device operate in accordance with a wireless local area network protocol.

30. The apparatus of claim 23, where the network device is a mobile device.

31. The apparatus of claim 23, said controller further configurable to periodically revise the content of the table to at least one of store a new medium access control address of a network device and to remove a previously stored medium access control address of a network device.

32. A method, comprising:
storing a table that contains identifications of certain ones of network devices; and
communicating at least part of a content of the table to at least one wireless network access node for use when operating the wireless network access node in a hidden mode of operation such that the wireless network access node transmits a probe response to a probe request that is received from a network device having an identification stored in the table.

33. The method of claim 32, where an identification is comprised of a medium access control address of a network device.

34. An apparatus, comprising:
means for storing a plurality of medium access control addresses individual ones of which are associated with an individual one of an authorized network device; and
means, responsive to operation of a wireless network access node in a hidden mode of operation, for transmitting a probe response only to a probe request that is received from a network device having a medium access control address in said storing means.

35. The apparatus of claim 34, where the network device is comprised of a mobile network device.
